(19) United States
(12) Patent Application Publication
(10) Pub. No.: US 2009/0268986 A1
(43) Pub. Date: Oct. 29, 2009

(54) SYSTEM FOR THE PLAYBACK OF MEDICAL IMAGES

(76) Inventors: Joerg Holstein, Sprockhoevel (DE); Klaus Dirk Kleber, Leverkusen (DE)

Correspondence Address: COLLARD & ROE, P.C., 1077 NORTHERN BOULEVARD, ROSLYN, NY, 11576, US

(21) Appl. No.: 12/312,446

(22) PCT Filed: Nov. 12, 2007
(86) PCT No.: PCT/EP2007/009760

§ 371 Date: Jun. 9, 2009

(30) Foreign Application Priority Data
Nov. 11, 2006 (DE) 10 2006 053 261.9

(51) Int. Cl. G06K 9/54

(52) U.S. Cl. 382/305

(57) ABSTRACT

A system for representing medical images in an operating theater has a PACS workstation and a display device that is connected to the PACS workstation for representing medical images stored in the PACS workstation. The display device has a large-size display area. In order to be able to efficiently and comfortably represent medical images in the operating theater, the PACS workstation is connected to a sterilizable remote control unit which is equipped with control elements for controlling the representation of the medical images by means of the display device that is connected to the PACS workstation.

The invention relates to a system for playback of medical images in an operating room, having a PACS workstation and a display device connected with the PACS workstation, for playback of medical images stored in the PACS workstation.

A Picture Archiving and Communication System (PACS) is a picture archiving and communication system used in medicine, on the basis of computers linked in a network. PACS systems record digital image data of all imaging examination modalities used in medicine. Modern radiological examination modalities yield digital image data. After having been recorded, these digital image data, together with information about the identity of the patient examined, about the clinical questions, and about the examination itself, are stored on a central server system. In the case of all systems commonly in use nowadays, standardized communication protocols and memory formats are used (e.g. DICOM). In this way, different PACS components and diagnosis devices can be linked in networks and used in combination, independent of manufacturer. The examination results are called up on special workstation computers that are also called PACS workstations [German word] or PACS workstations [English word]. Images are digitally processed, if necessary. After making an assessment by means of a PACS workstation, the radiologist draws up a findings report against the background of the patient's history, which report is also input into the system. Treating physicians can look at the images and the findings report on other PACS workstations that are connected with the network.

Nowadays, video projection possibilities already exist in operating rooms, in many cases, i.e. display devices having large-format display areas. These are usually disposed outside the sterile zone of the operating room, and produce an image that can easily be recognized by the surgeon, because of the size of the display area. Such display devices are mainly used in operating rooms in order to play back images recorded during an operation, by means of video cameras, endoscopy systems, or X-ray systems.

In order to allow access to images and findings from radiology during an operation, it is furthermore known to use PACS workstations of the type described above in the operating room. Use of a PACS workstation during an ongoing operation is not very practical, and this is disadvantageous. The PACS workstation is disposed outside the sterile zone of the operating room, so that the operating surgeon must move between OR table and PACS workstation in order to look at the images, if necessary. Furthermore, the operating surgeon himself cannot operate the PACS workstation (which is usually not sterile). This must be done by an assistant. However, it is particularly disadvantageous that the operating surgeon cannot look at the images that are of interest to him directly during the operation, from the OR table.

Against this background, it is the task of the invention to create a system that allows the operating surgeon to look at radiological image data stored in a PACS system, during an ongoing operation, in convenient and efficient manner.

This task is accomplished by the invention in that the display device connected with the PACS workstation has a large-format display area, whereby the PACS workstation is connected with a remote control unit, which has control elements for controlling the playback of the medical images by way of the display device connected with the PACS workstation.

According to the invention, the images stored in the PACS workstation are played back by way of a display device having a large-format display area, which is connected with the PACS workstation. The operating surgeon can see these images well from the OR table, even if the display device is situated outside the sterile zone of the operating room. A remote control unit, which in turn is connected with the PACS workstation, serves to control the playback of the medical images. It is practical if the remote control unit is configured so that it can be sterilized, so that the remote control unit can be disposed directly on the OR table. The operating surgeon himself can undertake control of the playback of the medical images and the selection of the images stored in the PACS workstation, during the ongoing operation, by means of the remote control unit. An assistant for operating the PACS workstation is not required. According to the invention, it is therefore possible to look at radiological images that are stored in a PACS system, in the operating room, in particularly efficient and convenient manner.

According to a practical embodiment of the system according to the invention, the remote control unit has a display device having a small-format display area for playback of the medical images stored in the PACS workstation. The operating surgeon can comfortably use the small-format display area to select images that are of interest to him, or to control the display of image details. The additional small-format display area makes the use of the remote control unit particularly convenient, since the operating surgeon only has to look at the remote control unit, which is situated directly at the OR table, when “navigating” in the image data stored in the PACS workstation. In other words, the operating surgeon does not have to look back and forth between the display device connected with the PACS workstation and the remote control unit. He can concentrate entirely on the remote control unit in order to control the image playback. For the remote control unit, a display device having a comparatively poorer quality of image playback is sufficient, in advantageous manner. The display device integrated into the remote control unit is only supposed to facilitate control of the image playback. The actual playback of the images, at optimal image quality, takes place by way of the large-format display area of the display device connected with the PACS workstation.

It is practical if the small-format display area of the display device integrated into the remote control unit is configured as a touch screen. A touch screen (also called a touchscreen or sensor image screen) is known to be a screen having regions that can be touched to produce control signals. Control can take place using a finger or a suitable pointer pen. In the case of the system according to the invention, a touch screen has the advantage that the operating surgeon can easily and conveniently select images or image regions that are of interest to him, simply by touching the display area. The touch screen allows particularly intuitive control. The touch screen can furthermore be used to display variable control fields, which can have different functions assigned to them, depending on the program context. It is therefore practical if the remote control device is set up for interactive selection of medical images or for selection of details of medical images, by means of touching the touch screen, whereby the selected images or image details are then played back by way of the display device connected with the PACS workstation.

In order to guarantee the most uncomplicated handling possible, the remote control unit of the system according to the invention can have a few control buttons having a fixed function. Thus, the remote control unit can have control buttons for switching between medical images, image series, and studies, for selecting playback protocols, which define the parameters for playback of the medical images (so-called hangings), for activating enlarged-size or reduced-size playback of the medical images, for influencing the brightness and/or the contrast of the image playback, and/or for starting and stopping the playback of a dynamic image series that consists of multiple images. In this way, the essential functions that are frequently required for image playback in the operating room are covered.

According to a practical further development of the system according to the invention, it is set up for automatic adaptation of the aspect ratios during playback of the medical images on the display device connected with the PACS workstation and/or on the display device of the remote control unit, namely in accordance with the image aspect ratio of the medical image being played back, in each instance, the display aspect ratio and the pixel aspect ratio of the display device, in each instance. The important thing is that both on the display device connected with the PACS workstation and on the display device of the remote control unit, playback of the images takes place in such a manner that the anatomical structures contained in the images are reproduced true to reality. Distortions resulting from different aspect ratios during playback must be avoided. In this connection, what must be considered is for one thing, the image aspect ratio, i.e. the ratio of width to height of the medical image being played back, in each instance, the display aspect ratio, i.e. the ratio of width to height of the display area, in each instance, and the pixel aspect ratio of the display device, in each instance, i.e. the ratio of width to height of the individual image pixels. All of these variables have to be known so that it can be assured that no distortions occur, by means of corresponding correction during image playback.

The display unit connected with the PACS workstation according to the invention can be a large-format screen of a known type, particularly an LCD, plasma, or CRT screen. Likewise, a projector for projection of the medical images to a projection area that can be easily seen by the operating surgeon is suitable. A commercially available video projector having a sufficient resolution can be used as a projector. A projector has the advantage that the projection area has a particularly large format, and thus allows image playback that is particularly easily recognized by the surgeon.

According to another practical embodiment, the remote control unit of the system according to the invention has means for voice recognition. This allows voice control of the image playback. The operating surgeon can interactively select the images or image details that are of interest to him by means of voice control. This has the advantage that he has both hands free for the operation to be performed.

An exemplary embodiment of the invention will be explained in greater detail in the following, using the drawings. These show:

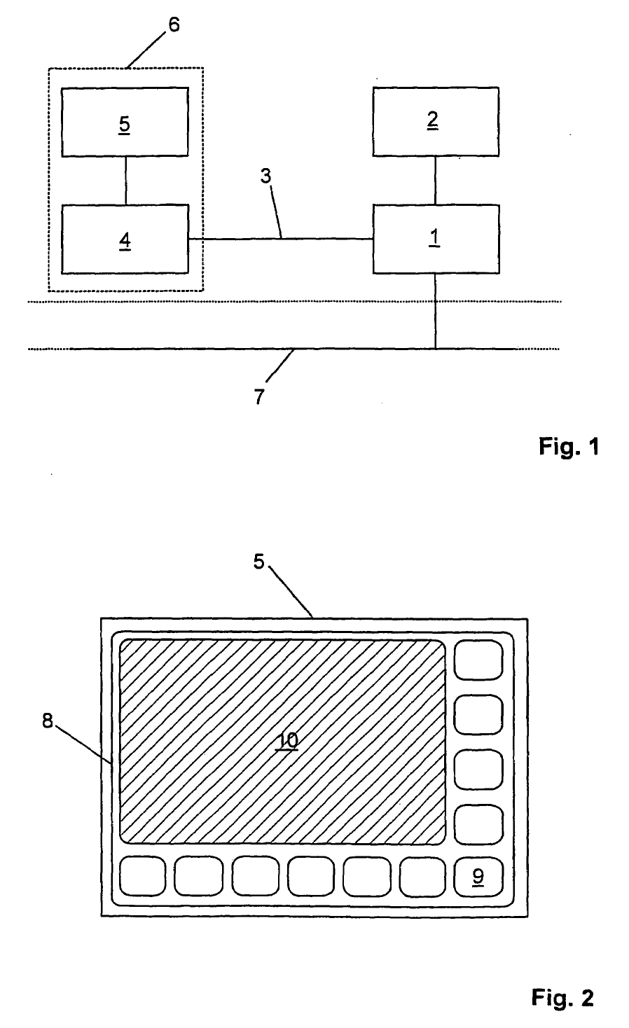

FIG. 1 block schematic representation of the system according to the invention;

FIG. 2 view of the remote control unit of the system according to the invention.

The system shown in FIG. 1 serves for playback of medical images in an operating room. The system comprises a PACS workstation 1, in which the image data to be played back are stored. A display device 2 is connected with the PACS workstation 1. The display device 2 can be a video projector that is able to project medical images at high quality and sufficient resolution. The video projector 2 projects the medical images onto a large-format projection area (not shown in any detail in FIG. 1). This allows playback of the images that is easily visible from the OR table, even if the video projector 2 and the related video projection area are situated outside the sterile zone of the operating room. A projection area having a diagonal of 50 cm or more can be viewed as having a large format in this sense, in any case. Even larger projection areas, which can easily be achieved with conventional, commercially available video projectors, are advantageous. The PACS workstation 1 is connected with a computer 4 by way of a conventional network connection 3. The computer 4 is a commercially available OR PC, i.e. a personal computer that meets the requirements in the operating room and can be sterilized. A screen 5, which can also be sterilized, is connected with the OR PC 4; its small-format display area is configured as a touch screen. The OR PC 4 together with the monitor 5 forms a remote control unit 6 by means of which playback of the medical images by way of the video projector 2 connected with the PACS workstation 1 can be controlled. At least the monitor 5 is directly disposed on the OR table, so that the operating surgeon can easily and conveniently control the image playback from the OR table. An advantage of the arrangement shown in FIG. 1 is that it can be implemented, in problem-free manner, using commercially available components.

For the remote control functionality, all that is required is to make software capable of running on the OR PC 4 available. This software communicates with a corresponding software module that is installed on the PACS workstation 1 for this purpose, by way of the data connection 3.

The PACS workstation 1 is furthermore connected with a data network 7, so that there is access to the other DP systems in the hospital, for example to a conventional hospital information system (HIS) as well as to PACS servers on which the medical image data and findings are centrally kept on hand. The system shown in FIG. 1 can advantageously be used in combination with conventional OR planning software. For example, the remote control unit 6 can be used to automatically carry out coordination of the patient data (name, date of birth, etc.) with the HIS system, in order to produce the patient context, in preparation for an operation. In this connection, all the relevant image data are automatically (or partly automatically) preloaded to the PACS workstation by a PACS server connected with the data network 7.

FIG. 2 shows a schematic view of the display area 8 of the monitor 5, configured as a touch screen. Multiple control fields 9 are shown on the display area 8; they have specific functions assigned to them, by means of a corresponding configuration. The control fields 9 can be activated by touching the touch screen 8 with a finger. Thus, the control fields 9 form control buttons for switching between medical images, image series, and studies, for selecting playback protocols (hangings), for influencing the brightness and/or contrast of the image playback, as well as for starting and stopping the playback of a dynamic image series that consists of multiple images. Furthermore, a small-format display area 10 is provided, which represents for playback of an overview of the medical images simultaneously played back in large format by means of the video projector 2. The operating surgeon can select specific images or image details that are of interest to him, by means of touching the display area 10, and can shift the image detail that has been selected, in each instance. Accordingly, playback of the medical images is controlled by way of the PACS workstation 1. The display area 10 has a small format. The image diagonal preferably amounts to 50 cm or less.

It is important that in the case of large-format playback of the medical images by way of the projector 2, and simultaneous playback on the small-format display area 10, adaptation of the aspect ratios takes place in order to avoid distortions. The large-format playback and the small-format playback should reproduce the anatomical structures being shown as true to reality as possible, in each instance. It should be noted that the large-format display area, i.e. the projection area at which the video projector 2 is aimed, for example, and the small-format display area 10 have different aspect ratios. The projection area can have an aspect ratio of 16:9 or 16:10, while the small-format display area 10 has an aspect ratio of 4:3. During image playback, automatic adaptation (for example by means of corresponding image transformation) must take place, in order to avoid distortions resulting from the different aspect ratios. In this adaptation, the image aspect ratios of the medical images being played back, in each instance, as well as the pixel aspect ratios of the display device, in each instance, must furthermore be taken into consideration. The different display devices can have different pixel aspect ratios. For example, the small-format display area of the monitor 5 can have square pixels (pixels [English word), while the pixels of the video projector 2 are rectangular. This pixel aspect ratio (also called pixel metrics) must be taken into consideration in the image playback. If necessary, corrections have to be made during image playback, so that the small-format image playback and the large-format image playback are equally distortion-free.

1. System for playback of medical images in an operating room, having a PACS workstation (1) and a display device (2) connected with the PACS workstation (1), for playback of medical images stored in the PACS workstation (1), wherein the display device (2) has a large-format display area, whereby the PACS workstation (1) is connected with a remote control unit (6), which has control elements (9) for controlling the playback of the medical images by way of the display device (2) connected with the PACS workstation (1).

2. System according to claim 1, wherein the remote control unit (6) has a display device (5) having a small-format display area (10) for playback of the medical images stored on the PACS workstation (1).

3. System according to claim 2, wherein the small-format display area (10) is configured as a touch screen.

4. System according to claim 3, wherein the remote control unit (6) is set up for interactive selection of medical images or for selection of details of medical images by means of touching the touch screen, whereby the selected images or image details are played back by way of the display device (2) connected with the PACS workstation (1).

5. System according to claim 1, wherein the remote control unit has control buttons (9) for switching between medical images, image series, and studies, for selecting playback protocols, which define parameters for playback of the medical images, for activating enlarged-size or reduced-size playback of the medical images, for influencing the brightness and/or the contrast of the image playback, and/or for starting and stopping the playback of a dynamic image series that consists of multiple images.

6. System according to claim 1, wherein it is set up for automatic adaptation of the aspect ratios during playback of the medical images on the display device (2) connected with the PACS workstation (1) and/or on the display device (5) of the remote control unit (6), namely in accordance with the image aspect ratio of the medical image being played back, in each instance, the display aspect ratio and the pixel aspect ratio of the display device (2, 5), in each instance.

7. System according to claim 1, wherein the display device (2) connected with the PACS workstation (1) is a large-format screen, particularly an LCD, plasma, or CRT screen, or a projector for projection of the medical images to a projection area.

8. System according to claim 1, wherein the remote control unit (6) has means for voice recognition.

9. System according to claim 1, wherein the PACS workstation (1) and the display device (2) connected with it are disposed outside the sterile zone, and the remote control unit (6) is disposed inside the sterile zone of the operating room.
